(19) United States
(12) Patent Application Publication
(10) Pub. No.: US 2026/0228820 A1
(43) Pub. Date: Aug. 6, 2026

(54) System, Method, and Device for Executing Computing Decisions for Other Entities

(71) Applicant: The Toronto-Dominion Bank, Toronto (CA)

(72) Inventors: Gurpreet Singh SOIN, Oshawa (CA); Hyejin CHO, Toronto (CA)

(73) Assignee: The Toronto-Dominion Bank, Toronto (CA)

(21) Appl. No.: 19/045,031

(22) Filed: Feb. 4, 2025

(51) Int. Cl. G06Q 40/03

(52) U.S. Cl. CPC G06Q 40/03

(57) ABSTRACT

System, method and device for executing decisions for local entities. The method includes providing a connection to enable local entities to communicate with a remote system in executing a process workflow and receive a decision request comprising a set of data obtained by the local entity from an interaction to execute a decision. The method also includes performing a preliminary segmentation of the set of data using a first predictive model to segment an interaction associated with the data into an upper or lower classification, assigning the interaction to a tier and apply a rule set according to the upper or lower classification, and performing a final segmentation of the set of data. The method includes applying a final decision tree according to the classification assigned to the interaction to determine the decision regarding the interaction, generating a result message for an application utilized by the local entity, and sending the result message to the application at the local entity.

### TECHNICAL FIELD

The following relates generally to methods for executing computing decisions and, more particularly, to executing decisions for other entities, for example executing decisions for a local entity by a remote system.

### BACKGROUND

Computing systems may include local and remote entities. Local entities may include a portal or other interface to a remote entity and rely on the remote entity to offload certain processing steps in a workflow. However, the introduction of local-remote configurations can create latency and even bottleneck issues if the local entity requires steps to be executed in real-or near-real-time. In such cases, reliance on the remote entity may become a burden rather than an advantage.

### BRIEF DESCRIPTION OF THE DRAWINGS

Embodiments will now be described with reference to the appended drawings wherein:

FIG. 1 is a schematic diagram of an example computing environment.

FIG. 2 illustrates a remote decision engine coupled to a local service provider platform to execute decisions for the local service provider in servicing requests.

FIG. 3 is a block diagram of an example configuration of a decision engine.

FIG. 4 is a block diagram of an example configuration for an enterprise system having a mainframe.

FIG. 5 illustrates an example data flow between a local entity and a remote system in utilizing the remote system to execute a decision.

FIG. 6 illustrates an example multi-stage segmentation process utilized by a decision engine.

FIG. 7 illustrates results of an example of a primary segmentation.

FIG. 8 illustrates confusion matrices utilized in the primary segmentation.

FIGS. 9a and 9b show graphs illustrating a cumulative lift effect and a receiver operator characteristic (ROC) curve.

FIG. 10 illustrates results of an example of a risk tier assessment.

FIG. 11 illustrates an example of a decline rule set.

FIG. 12 illustrates a final segmentation example.

FIG. 13 illustrates a feature selection example from the final segmentation.

FIG. 14 illustrates a performance evaluation for the final segmentation.

FIGS. 15a, 15b, and 15c illustrate a pre-qualification decision example used to generate a response to the request.

FIG. 16 is a block diagram of an example configuration of a client device used to interface with, for example, the self-serve data platform.

FIG. 17 is a flow chart illustrating example operations that may be performed in executing decisions for a local entity by a remote system.

FIG. 18 is a flow chart illustrating example operations that may be performed in augmenting preliminary decision data with a set of data utilized in executing a decision.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The following describes a decision engine and local-remote computing configuration that enables a local entity such as a dealer, client-facing establishment, or other service provider to leverage a remote entity to execute decisions using the decision engine. The decision engine and remote entity can utilize access control permissions and access to client data, decision making data (e.g., market data, statistical data, client history, etc.) and data associated with a large group of users and clients, to provide faster and more accurate decisions for the local entity. For example, the local entity can use the decision engine to segment a client to determine if they qualify for a product or service associated with a request made by a client device. By having a centralized remote entity and decision engine, several local entities can leverage the system concurrently while taking advantage of the scale, further accuracy, and insights available through access to a centralized and generally larger set of data, e.g., an enterprise client database, without exposing the underlying data to additional security risk.

For example, the configuration and system described herein may be used to create a portal that can be utilized directly by dealers, e.g., auto dealers, to reach a backend system to perform a pre-qualification(s) while the customer is being attended to, i.e., in real time.

Pre-qualification is a process used in many lending scenarios to determine if a customer is suitable or to determine a borrowing limit, etc., prior to engaging in a full qualification process, where the full qualification process can be expensive, time consuming, etc. Pre-qualification can therefore be a useful tool to screen customers that are unlikely to qualify for a loan (e.g., to finance an automobile, recreational vehicle, etc.) in order to avoid wasting the customer's time, and to avoid the expense associated with qualification processes only to decline the potential borrower.

Pre-qualification can be difficult to implement, particularly in some applications like auto loans. In addition to the technical challenges of being able to obtain a pre-qualification in real-time while helping a potential customer, many times the dealer needs to make multiple different requests to determine if different scenarios work, which can stress the computing architecture used to assess the pre-qualification, among other issues. Moreover, there is a desire to avoid too many (or even any) queries to a credit bureau to avoid affecting a customer's credit score. That is, it is desirable to be able to determine, with some degree of accuracy, whether a customer can be pre-qualified without a “hit” on the credit bureau, to achieve the aforementioned benefits of avoiding the expense of performing qualification customers that are unlikely to satisfy the qualification process, and to do so in a manner that does not put off the customer.

The portal can be created using the configuration and by leveraging access to the decision engine. This allows dealers and other service provider computing platforms to directly access the decision engine and use this connection multiple times in real-time while handing client requests. In one example, dealers such as auto dealers can reach a backend system to perform a pre-qualification(s) while the customer is being attended to, i.e., in real time. The backend system is configured to use a series of unique segmentation steps, utilizing machine learning (ML) or other artificial intelligence (AI) tools such as large language models (LLMs), to obtain an accurate determination of whether the customer can qualify (e.g., for the loan), without sacrificing speed or the customer experience (e.g., come back later, etc.). That is, the segmentations performed by the backend enable a “good enough” determination to make quick and accurate decisions for pre-qualification.

According to one aspect, a system for executing decisions for local entities is provided. The remote system includes a processor, a communication module coupled to the processor, and a memory coupled to the processor. The memory stores computer executable instructions that when executed by the processor cause the remote system to provide a connection to enable local entities to communicate with the remote system in executing a process workflow; receive via the connection, from a local entity, a decision request comprising a set of data, the set of data being obtained by the local entity from an interaction to execute a decision; perform a preliminary segmentation of the set of data using a first predictive model to segment interaction into an upper or lower classification; assign the interaction to a tier and apply a rule set according to the upper or lower classification; perform a final segmentation of the set of data, wherein for interactions classified as the lower classification, utilize a second predictive model to further classify the interaction into a near upper classification or the lower classification; apply a final decision tree according to the classification assigned to the interaction to determine the decision regarding the interaction; generate a result message for an application utilized by the local entity, the application having access to the connection, wherein upper or near upper classified client entities receive a second set of data from the system to enable the local entity to continue executing the process workflow for that interaction; and send the result message to the application at the local entity.

In certain example embodiments, the decision comprises an approval or denial of a service to the client entity.

In certain example embodiments, the system further includes instructions that when executed by the processor cause the system to query a third-party service to obtain preliminary decision data; and augment the set of data with the preliminary decision data.

In certain example embodiments, the preliminary decision data comprises data indicative of qualification for receiving a service associated with the process workflow.

In certain example embodiments, the tier is associated with a risk.

In certain example embodiments, risk tiers are determined from associated look-up tables.

In certain example embodiments, the rule set comprises a segmented chart, the segmented chart comprising a plurality of rule categories.

In certain example embodiments, the preliminary segmentation comprises a feature selection process using a confusion matrix.

In certain example embodiments, the final segmentation comprises a feature selection process using a confusion matrix.

In certain example embodiments, the result message provides a prequalification decision that triggers a full qualification process.

In certain example embodiments, result messages comprising a negative decision inhibit the full qualification process from commencing.

In another aspect, there is provided a method for executing decisions for local entities. The method includes providing a connection to enable local entities to communicate with a remote system in executing a process workflow; receiving via the connection, from a local entity, a decision request comprising a set of data, the set of data being obtained by the local entity from an interaction to execute a decision; performing a preliminary segmentation of the set of data using a first predictive model to segment interaction into an upper or lower classification; assigning the interaction to a tier and apply a rule set according to the upper or lower classification; performing a final segmentation of the set of data, wherein for interactions classified as the lower classification, utilize a second predictive model to further classify the interaction into a near upper classification or the lower classification; applying a final decision tree according to the classification assigned to the interaction to determine the decision regarding the interaction; generating a result message for an application utilized by the local entity, the application having access to the connection, wherein upper or near upper classified client entities receive a second set of data from the system to enable the local entity to continue executing the process workflow for that interaction; and sending the result message to the application at the local entity.

In certain example embodiments, the decision comprises an approval or denial of a service to the client entity.

In certain example embodiments, the method further includes querying a third-party service to obtain preliminary decision data; and augmenting the set of data with the preliminary decision data.

In certain example embodiments, the preliminary decision data comprises data indicative of qualification for receiving a service associated with the process workflow.

In certain example embodiments, the rule set comprises a segmented chart, the segmented chart comprising a plurality of rule categories.

In certain example embodiments, the preliminary segmentation comprises a feature selection process using a confusion matrix.

In certain example embodiments, the final segmentation comprises a feature selection process using a confusion matrix.

In certain example embodiments, the result message provides a prequalification decision that triggers a full qualification process.

In another aspect, there is provided a computer readable medium storing computer-executable instructions for executing decisions for local entities, comprising computer-executable instructions that, when executed by a remote computing system, cause the remote system to: provide a connection to enable local entities to communicate with the remote system in executing a process workflow; receive via the connection, from a local entity, a decision request comprising a set of data, the set of data being obtained by the local entity from an interaction to execute a decision; perform a preliminary segmentation of the set of data using a first predictive model to segment interaction into an upper or lower classification; assign the interaction to a tier and apply a rule set according to the upper or lower classification; perform a final segmentation of the set of data, wherein for interactions classified as the lower classification, utilize a second predictive model to further classify the interaction into a near upper classification or the lower classification; apply a final decision tree according to the classification assigned to the interaction to determine the decision regarding the interaction; generate a result message for an application utilized by the local entity, the application having access to the connection, wherein upper or near upper classified client entities receive a second set of data from the system to enable the local entity to continue executing the process workflow for that interaction; and send the result message to the application at the local entity.

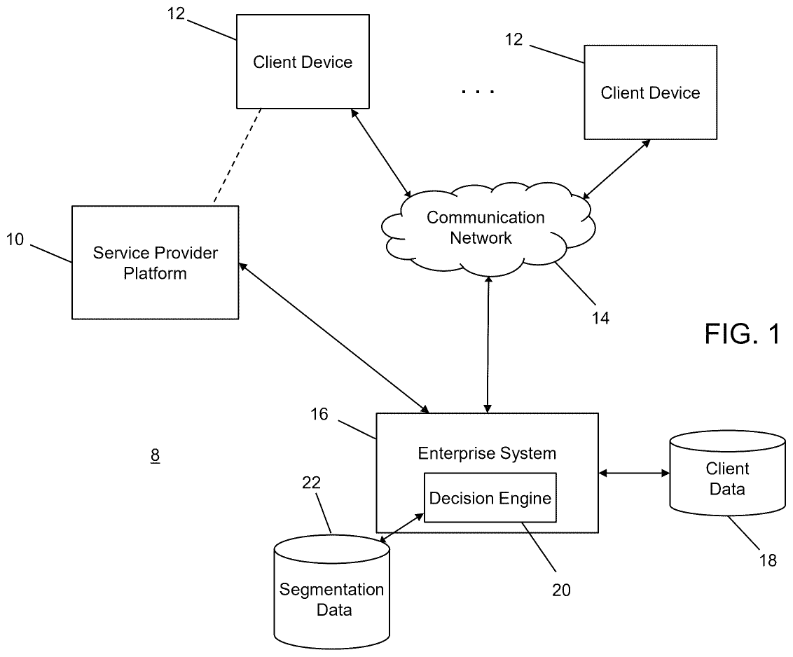

Referring now to the figures, FIG. 1 illustrates an example of a computing environment 8 having a local and remote configuration. In one aspect, the computing environment 8 may include one or more client devices 12, and one or more communications networks 14 connecting the components of the computing environment 8. The client devices 12 may include or otherwise have access to a service provider platform 10 via the communication network 14 or directly, e.g., when located in a same local environment within the computing environment 8.

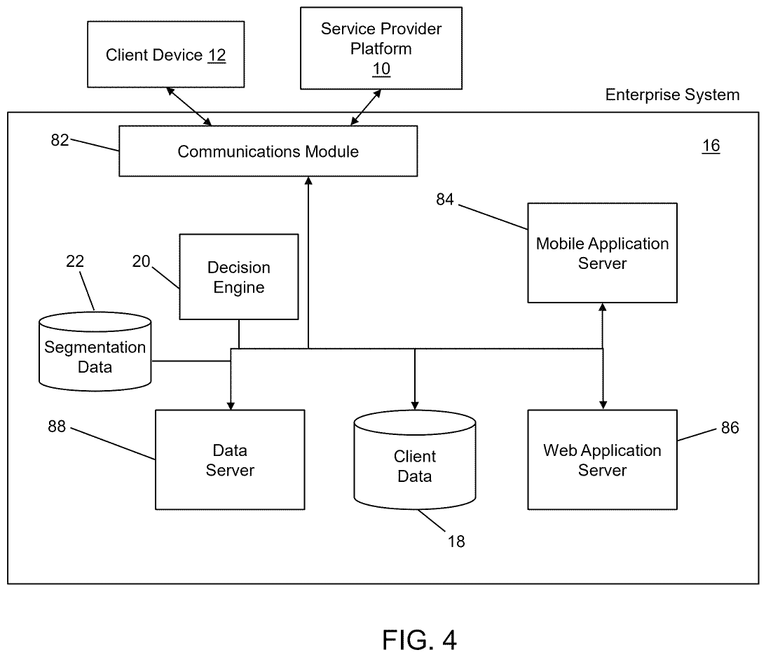

The computing environment 8 may also include an enterprise system 16 (e.g., a financial institution such as commercial bank and/or insurance provider) that provides financial services accounts to users and processes financial transactions associated with those financial service accounts. While several details of the enterprise system 16 have been omitted for clarity of illustration, reference will be made to FIG. 4 below for additional details. The enterprise system 16 includes, at least in part, a decision engine 20. The decision engine 20 includes or has access to segmentation data 22, used in executing decisions for the service provider platform 10.

The enterprise system 16 also includes or otherwise has access to a datastore for storing client data 18. The enterprise system 16 may include other datastores not shown in FIG. 1. The data associated with a user can include client profile data that may be mapped to corresponding financial data for that user. It can be appreciated that the financial data could also include transaction data and/or the client data 18 shown in FIG. 1 and these datastores are described separately for illustrative purposes. The client data 18 can include both data that is associated with a client as well as data that is associated with one or more user accounts for that client as recognized by the computing environment 8.

The data associated with a client may include, without limitation, demographic data (e.g., age, gender, income, location, etc.), preference data input by the client, and inferred data generated through machine learning, modeling, pattern matching, or other automated techniques. The client data 18 may also include historical interactions and transactions associated with the enterprise system 16, e.g., login history, search history, communication logs, documents, etc.

Client devices 12 may be associated with one or more users. Users may be referred to herein as customers, clients, policy holders, correspondents, or other entities that interact with the service provider platform 10 and/or the enterprise system 16 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with a mobile or web-based financial (banking) application which uses or incorporates subsystems of the enterprise system 16, discussed further below.

The client devices 12 can access information within the service provider platform 10 and/or enterprise system 16 or another remote computing environment associated with the enterprise system 16 in a variety of ways. For example, the client device 12 can access the service provider platform 10 or enterprise system 16 via a web-based application, or a dedicated application. Access can require the provisioning of different types of credentials (e.g., login credentials, two factor authentication, etc.). In example embodiments, each different device 12 can be provided with a unique degree of access, or variations thereof. For example, the client device 12 can be provided with a greater degree of access to the enterprise system 16 compared to other devices.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The enterprise system 16 can be understood to encompass the whole of the enterprise, a subset of a wider enterprise system (not shown), such as a system serving a subsidiary, or a system for a particular branch or team of the enterprise (e.g., a resource migration division of the enterprise). In at least one example embodiment, the enterprise system 16 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc. Financial institutions can generate vast amounts of data, and have vast amounts of existing records, both of which can be difficult to migrate into a digital and remote computing environment.

The enterprise system 16 may include both on-premises and remote computing assets provided by a remote computing environment—not shown (hereinafter referred to in the alternative as computing resources). The remote computing environment includes resources used by, or available to, the enterprise system 16 that are stored or managed by a party other than the operator of the enterprise system 16. For example, the computing resources can include cloud-based storage services (e.g., database(s)). In at least some example embodiments, the computing resources include one or more tools developed or hosted by the external party, or tools for interacting with the computing resources. In at least one contemplated embodiment, the tool (referred to in the singular for ease of reference) is a tool for managing data lakes, and more specifically a tool for scheduling writing to a data lake associated with the Microsoft™ Azure™ data storage and processing platform. Further particularizing the example, the tool can allow a client device 12 to access the computing resources, and to thereafter configure an ingestion procedure wherein different data files are assigned to different processors (e.g., hardware) within the computing resources based on a configuration file. The tool can be or include aspects of a machine learning tool, or a tool associated with the Delta Lake Storage (ALDS)™ suite, etc. The computing resources can also include hardware resources, such as access to processing capability of server devices (e.g., cloud computing), and so forth.

The service provider platform 10 is shown as a separate entity in FIG. 1 for illustrative purposes and, in other configurations, may be part of or otherwise integrated into/with the enterprise system 16. As shown in FIG. 1, the service provider platform 10 may be coupled to or in communication with the decision engine 20, via the enterprise system 16, to permit a user of a client device 12 to obtain a decision related to a request that is submitted via the service provider platform 10, considered a local entity relative to the remote decision engine 20 and enterprise system 16.

Referring back to FIG. 1, the enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the enterprise system 16. The cryptographic server may be used to protect the financial data and/or client data 18 by way of encryption for data protection, digital signatures or message digests for data integrity, and by using digital certificates to authenticate the identity of the users and client devices 12, with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

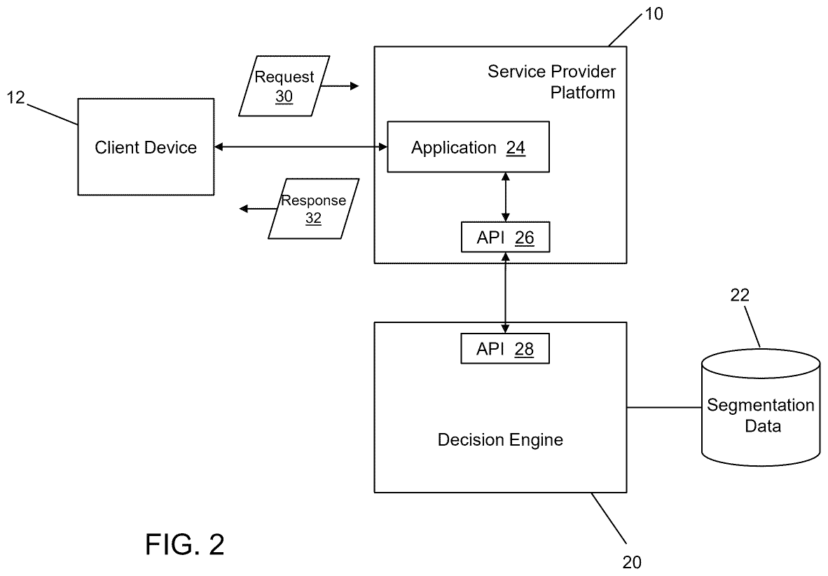

Turning now to FIG. 2, an example of a local-remote computing configuration is shown, which enables the service provider platform 10 to utilize the decision engine 20 located at a remote entity or remote computing system or platform such as the enterprise system 16. The configuration shown in FIG. 2 illustrates a single local entity, namely the service provider platform 10, however, it can be appreciated that any number of locally situated service provider platforms 10 and/or other computing devices, systems, or platforms may have access to a centrally and remotely located decision engine 20 to enable segmentation of requesting entities to generate a decision that can be used in responding to a request by a user or client, e.g., via that user's client device 12 or a client device 12 used by an administrator or agent of the service provider platform 10 (e.g., dealership qualification scenario discussed above).

The service provider platform 10 in this example includes an application 24, which may be or include a portal to the decision engine 20. For example, the application 24 may include or make calls to an API 26 that communicates with a remote API 28 exposed by the decision engine 20. It can be appreciated that APIs 26, 28 are only one example of a computing interface that enables the application 24 to communicate with and exchange data with the decision engine as described herein.

The client device 12 may be a user's device or, when the user is in person at an establishment, may be a client device 12 used by an agent or administrator that is handling a request 30 made by the user, e.g., to obtain a qualification or other decision regarding a product or service, e.g., for purchasing, leasing, upgrading, accessing, trading, transferring, etc. For example, as described in an example below, the decision engine 20 may be used to determine if the user or entity associated with the client device 12 or utilizing the client device 12 meets certain criteria based on segmentation data 22 among other factors that can be determined by applying ML/AI techniques using data provided by the service provider platform 10 to the decision engine 20 via a portal such as the application 24 and/or APIs 26, 28. In this way, a decision can be executed or made or otherwise enabled allowing the service provider platform 10 to return a response 32 to the request 30 via or to/from the client device 12.

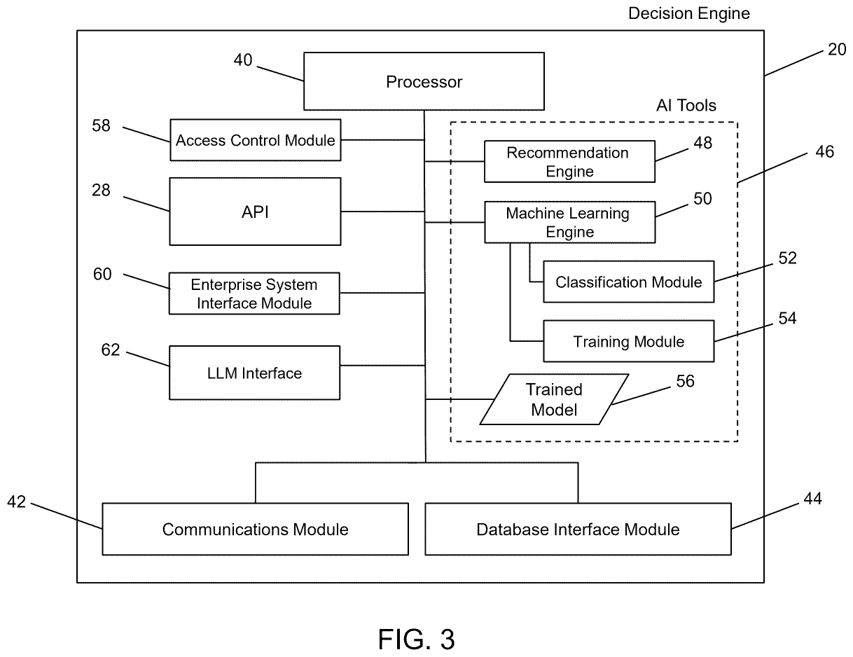

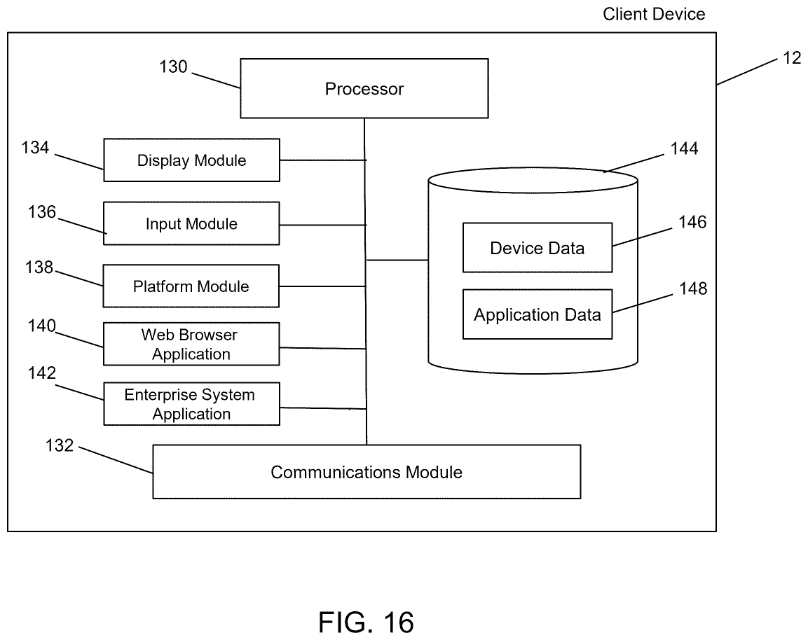

In FIG. 3, an example configuration of the decision engine 20 is shown. In certain embodiments, the decision engine 20 may include one or more processors 40, a communications module 42, and a database interface module 44 for interfacing with the datastores for the segmentation data 22, among other data sources, to retrieve, modify, and store (e.g., add) data. Communications module 42 enables the decision engine 20 to communicate with one or more other components of the computing environment 8, such as client device 12 (or one of its components-see FIG. 16), via a bus or other communication network, such as the communication network 14. While not delineated in FIG. 3, the decision engine 20 includes at least one memory or memory device that can include a tangible and non-transitory computer-readable medium having stored therein computer programs, sets of instructions, code, or data to be executed by processor 40.

FIG. 3 illustrates examples of modules, tools and engines stored in memory on the decision engine 20 and executed by the processor 40. It can be appreciated that any of the modules, tools, and engines shown in FIG. 3 may also be hosted externally and be available to the decision engine 20, e.g., via the communications module 42. In the example embodiment shown in FIG. 3, the decision engine 20 includes a suite or set of AI tools 46. The AI tools 46 include or otherwise have access to a recommendation engine 48, a machine learning engine 50, a classification module 52, a training module 54, and at least one trained model 56. The decision engine 20 also includes an access control module 58 and the API 28 to permit access to the decision engine 20 by the application 24 hosted by the service provider platform 10. The decision engine 20 also includes an LLM interface 62 to enable the decision engine 20 and the AI tools 46 to access an LLM (e.g., third party LLM for generating responses to requests, etc.), and an enterprise system interface module 60.

The recommendation engine 48 is used by the AI tools 46 of the decision engine 20 to generate one or more recommendations for the decision engine 20 and/or a client device 12 that is/are related to generating UIs, generating code for such UIs, generating test cases, etc. It may be noted that a recommendation as used herein may refer to a prediction, suggestion, inference, association or other recommended identifier that can be used to generate a suggestion, notification, command, instruction or other data that can be viewed, used or consumed by the decision engine 20. The recommendation engine 48 can access segmentation data 22 or other data and information, and apply one or more inference processes to generate the recommendation(s). The recommendation engine 48 may utilize or otherwise interface with the machine learning engine 50 to both classify data currently being analyzed to generate a suggestion or recommendation, and to train classifiers using data that is continually being processed and accumulated by the decision engine 20. That is, the recommendation engine 48 can learn segmentation outcomes, risk tiers and risk assessments, utilize confusion matrices, etc., and revise and refine classifications, rules, or other analytics-related parameters over time. For example, the trained model 56 can be updated and refined using the training module 54 as client devices 12 and/or service provider platforms 10 interact with the decision engine 20 during various interactions to improve the AI/ML parameters and understanding of how testing is implemented, monitored, and fixed.

The machine learning engine 50 may also perform operations that classify the segmentation and other data (e.g., client data 18) in accordance with corresponding classifications parameters, e.g., based on an application of one or more machine learning algorithms to the data or groups of the data. The machine learning algorithms may include, but are not limited to, a one-dimensional, convolutional neural network model (e.g., implemented using a corresponding neural network library, such as Keras®), and the one or more machine learning algorithms may be trained against, and adaptively improved, using elements of previously classified profile content identifying suitable matches between content identified and potential actions to be executed. Subsequent to classifying the decision-related content or content being analyzed, the recommendation engine 48 may further process each element of the content to identify, and extract, a value characterizing the corresponding one of the classification parameters, e.g., based on an application of one or more additional machine learning algorithms to each of the elements of the decision-related content. By way of example, the additional machine learning algorithms may include, but are not limited to, an adaptive natural language processing (NLP) algorithm that, among other things, predicts starting and ending indices of a candidate parameter value within each element of the content, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified content. The LLM interface 62 may be used to additionally access and prompt an LLM (not shown) for creating generative content. Classification parameters may be stored and maintained using the classification module 52, and training data may be stored and maintained using the training module 54.

The trained model 56 may also be created, stored, refined, updated, re-trained, and referenced by the decision engine 20 (e.g., by way of the AI tools 46) to determine associations between testing-related messages or commands, and suitable responses or actions, and/or content related thereto. Such associations can be used to generate recommendations or suggestions for improving decisions being made, e.g., for qualification or other approve/deny type decisions.

In some instances, classification data stored in the classification module 52 may identify one or more parameters, e.g., “classification” parameters, that facilitate a classification of corresponding elements or groups of recognized content based on any of the exemplary machine learning algorithms or processes described herein. The one or more classification parameters may correspond to parameters that can indicate an affinity or compatibility between decision parameters and outcomes (e.g., approve or deny), and certain potential actions.

In some instances, the additional, or alternate, machine learning algorithms may include one or more adaptive, NLP algorithms capable of parsing each of the classified portions of the content and predicting a starting and ending index of the candidate parameter value within each of the classified portions. Examples of the adaptive, NLP algorithms include, but are not limited to, NLP models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of event data (e.g., a value or type of data being augmented with an event or workflow) and a single classification parameter and additionally, or alternatively, multiple classification parameters.

Based on the output of the one or more machine learning algorithms or processes, such as the one-dimensional, convolutional neural network model described herein, machine learning engine 50 may perform operations that classify each of the discrete elements of decision-related content as a corresponding one of the classification parameters, e.g., as obtained from classification data stored by the classification module 52.

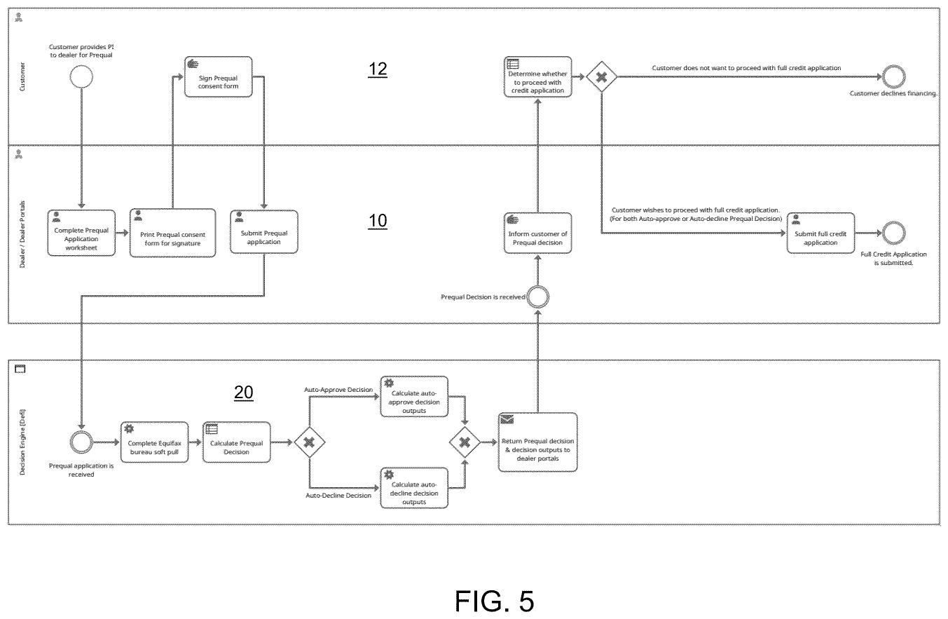

The outputs of the machine learning algorithms or processes may then be used by the recommendation engine 48 to generate one or more suggested recommendations, instructions, commands, notifications, rules, or other instructional or observational elements that can be presented to the AI tools 46. The AI tools 46 may be used by any one or more of the stages shown in FIGS. 5 through 15 described below. Similarly, the AI tools 46 may use the LLM interface 62 to access third party sources such as GPT-type services that use their own LLMs.

In FIG. 4, an example configuration of an enterprise system 16 is shown. The enterprise system 16 includes a communications module 82 that enables the enterprise system 16 to communicate with one or more other components of the computing environment 8, such as the service provider platform 10 and/or client device(s) 12, via a bus or other communication network, such as the communication network 14. While not delineated in FIG. 4, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 4 illustrates examples of servers and datastores/databases operable within the enterprise system 16. It can be appreciated that any of the components shown in FIG. 4 may also be hosted externally and be available to the enterprise system 16, e.g., via the communications module 82. In the example embodiment shown in FIG. 4, the enterprise system 16 includes one or more servers to provide access to client data 18, e.g., for making decisions related to a particular client or entity (e.g., user of client device 12). Exemplary servers include a mobile application server 84, a web application server 86 and a data server 88. The enterprise system 16 also includes the decision engine 20, e.g., to enable the service provider platform 10 to communicate with the decision engine 20 via the enterprise system 16 and any interfaces that may already existing therefor. Although not shown in FIG. 4, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storage elements for storing and providing data for use in such services, such as data storage for storing client data 18.

Mobile application server 84 supports interactions with a mobile application installed on client device 12 (which may be similar or the same as a test device). Mobile application server 84 can access other resources of the enterprise system 16 to carry out requests made by, and to provide content and data to, a mobile application on client device. In certain example embodiments, mobile application server 84 supports a mobile banking application to provide payments from one or more accounts of user, among other things.

Web application server 86 supports interactions using a website accessed by a web browser application running on the client device. It can be appreciated that the mobile application server 84 and the web application server 86 can provide different front ends for the same application, that is, the mobile (app) and web (browser) versions of the same application. For example, the enterprise system 16 may provide a banking application that be accessed via a smartphone or tablet app while also being accessible via a browser on any browser-enabled device.

The client data 18 can include, in an example embodiment, financial data that is associated with users of the client devices (e.g., customers of the financial institution). The financial data may include any data related to or derived from financial values or metrics associated with customers of a financial institution system (i.e. the enterprise system 60 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

It will be appreciated that only certain modules, applications, tools, and engines are shown in FIGS. 3 and 4 for ease of illustration and various other components would be provided and utilized by the service provider platform 10, enterprise system 16, and decision engine 20, as is known in the art.

Referring now to FIG. 5 an example of workflow implemented by the service provider platform 10 in conjunction with the decision engine 20 via a local/remote computing configuration in the computing environment 8 is shown. In this example, the user or entity associated with the client device 12 provides to the service provider platform 10 personal information (PI), to enable the dealer or agent to complete a prequalification application worksheet. In this example, a consent form is prepared and provided back to the client to enable the prequalification application to be submitted.

The prequalification application is received by the decision engine 20 (or the enterprise system 16 for the decision engine 20). Optionally, as shown, the decision engine 20 performs a “soft pull” from a third-party service such as a credit bureau, e.g., to obtain a credit score and/or other information without a full “hit” on the customer's profile. The decision engine 20 then calculated a prequalification decision as illustrated further below, which can lead to either an auto-approve decision or an auto-decline decision. The auto-approve decision then leads to the calculation of auto-approve decision outputs. Similarly, the auto-decline decision leads to the calculation of auto-decline decision outputs. For example, the auto-approve or auto-decline may include different messaging or notifications which can be predefined or generated, e.g., by using an LLM. The decisions lead to preparation of a prequalification decision and decision output(s) that is/are sent back to the dealer portal, i.e., the application 24 via APIs 26, 28.

The prequalification decision is received by the service provider platform 10, which can inform the user, client, customer, or other entity, e.g., via the client device 12 or in person. Based on this prequalification decision, the user may determine whether to proceed with a full application. By having the decision engine's determination at that time, unlikely qualifications can be avoided thus reducing the time, processing power and storage and bandwidth requirements utilized by the overall system. If a full application is desired, this may transition to another process. It can be appreciated that when informing the customer of the prequalification decision, a further attempt may be attempted, e.g., by modifying certain parameters of the application. The rapid generation of a prequalification decision using the decision engine 20 thus not only avoids applications unlikely to prevail but also allows the service provider platform 10 to revise and tweak an application by trying different things that may increase the likelihood for success. Such multiple iterations may be done automatically, e.g., by attempting multiple levels or tiers of parameters in succession until an approval is obtained. Alternatively, these iterations may be attempted manually or semi-manually.

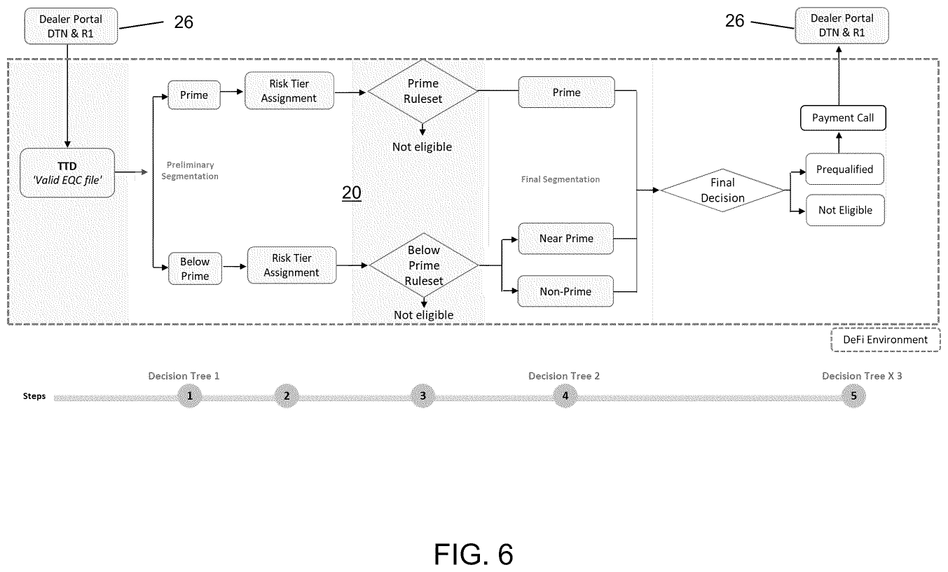

The prequalification strategy that is used to calculate the pre-qualification decision is shown in FIG. 6. A preliminary segmentation separates the customers into prime or below prime, each having a different risk tier assignment. Then, a prime or below prime rule set is applied to determine if the customer is prime, near prime, non-prime or not eligible. A decision tree is then evaluated in a final segmentation, which enables a final decision to be made, namely whether the customer is prequalified or not eligible so that an appropriate response can be returned, e.g., payment call or denial.

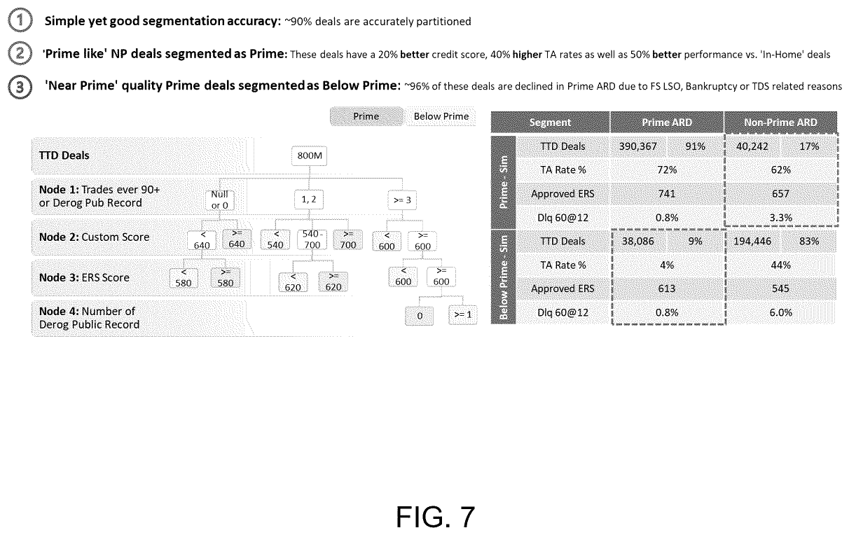

FIGS. 7-11 illustrate an example of preliminary segmentation and risk tier assessment processes.

As shown in FIGS. 6 and 7, the applications are classified into two segments, namely “prime” and “below prime” using a predictive model 56 that considers credit scores, historical tradeline performance and public records on the bureau file. This may include client data 18 by utilizing access by the decision engine 20 via the enterprise system 16.

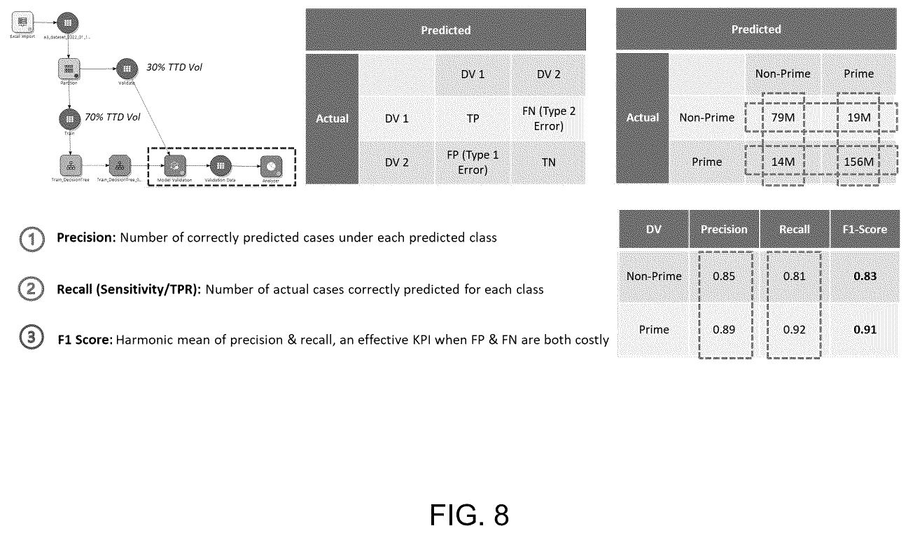

The segments shown in FIG. 7 demonstrate that approximately 90% of the deals can be accurately partitioned. In the diagrams shown in FIG. 8, a confusion matrix is representative of a validation dataset.

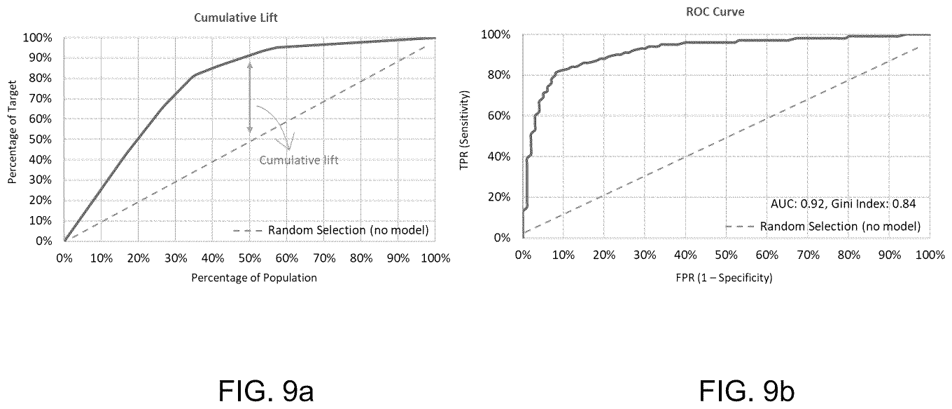

In FIG. 9a, a cumulative lift chart demonstrates the effectiveness of the model 56 in selecting a target category compared to no model at all (i.e., random selection). By covering 50% of the deals, the model 56 can correctly identify 90% of the non-prime deals in this example.

The ROC curve in FIG. 9b is a probability curve and the area under curve (AUC) represents the degree or measure of separability. The higher the AUC, the better the model's performance at distinguishing between classes. That is, the trained model 56 is found to do a good job in separating “signal” from “noise”. In this example, there is a 92% chance that the model will distinguish classes accurately.

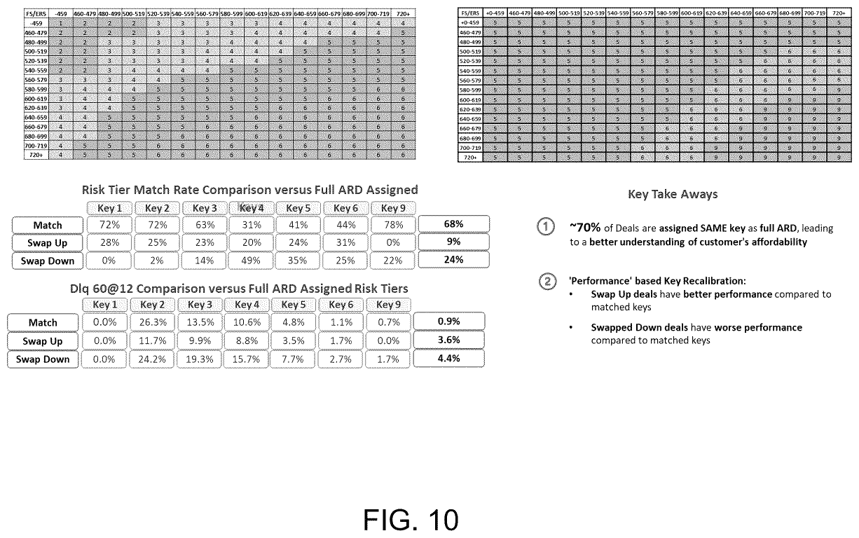

In a second process (see FIG. 6), risk tier assignments are determined for performance-based recalibration. An example of a risk tier assignment is shown in FIG. 10. Here, 60@12 Delinquency is chosen as a metric to assign risk tiers, which in turn will determine APRs for prequalified customers. CY2021 cohort's ‘24MOB’ performance window was used as a benchmark to assign new performance-based risk tier, as shown in FIG. 10.

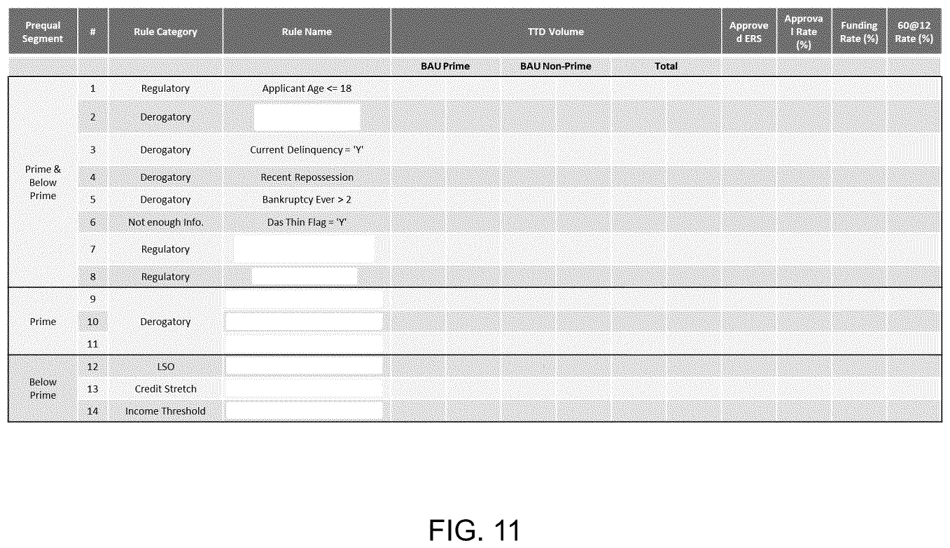

Referring now to FIG. 11, in a third process, an auto decline ruleset is applied. As shown, rules for prime and below prime, prime and below prime “tiers” may be created, with certain metrics associated.

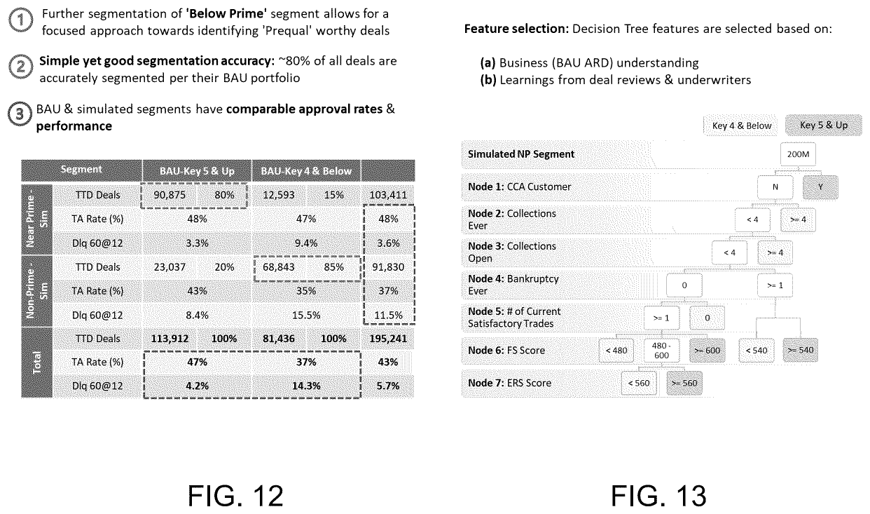

Referring now to FIGS. 12-15, in a fourth process, the final segmentation performs a further segmentation of the “below prime” to allow for a focused approach towards identifying “prequal” worthy deals as shown in FIG. 12. Feature selection is shown by way of example in FIG. 13.

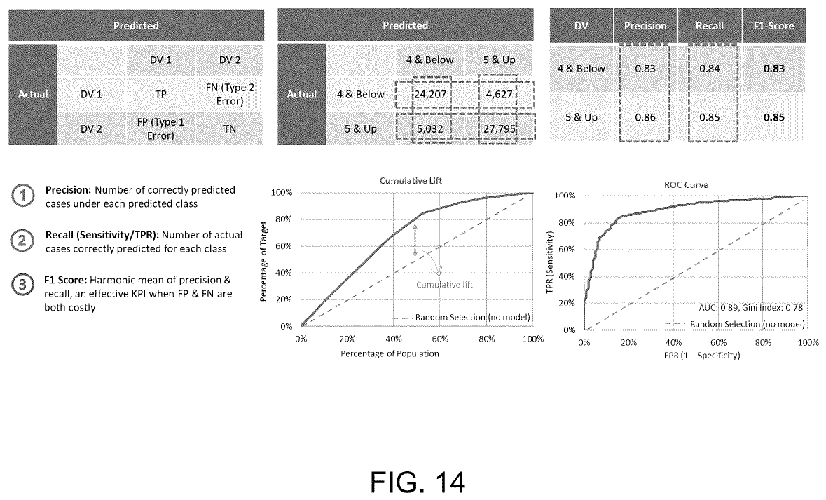

A performance evaluation of the final segmentation is shown in FIG. 14. The confusion matrix is representative of a validation dataset (from a randomly selected 30% of deals from a particular period of time). The cumulative lift diagram illustrates the precision.

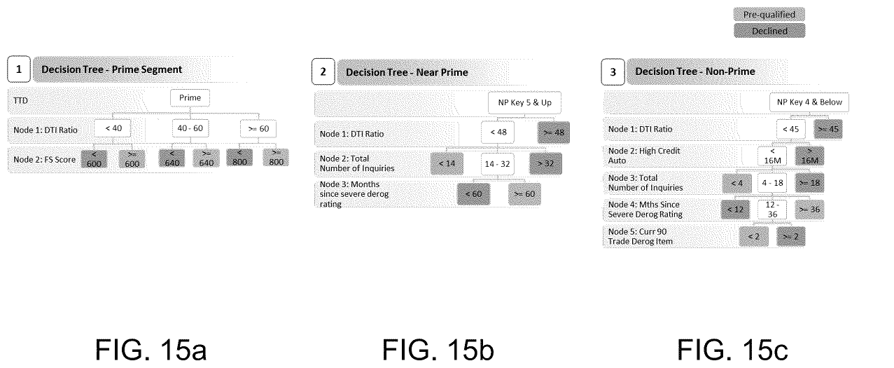

The pre-qualification decision engine, namely the fifth step, is illustrated in FIGS. 15a, 15b, and 15c. Here a tree graph using ratio and score decision points at nodes can place the customer into a particular segment for a tier of customer (e.g., prime, below prime, non-prime).

In FIG. 16, an example configuration of a client device 12 is shown. In certain embodiments, the client device 12 may include one or more processors 130, a communications module 132, and a data store 144 storing device data 146 and application data 148. Communications module 132 enables the client device 12 to communicate with one or more other components of the computing environment 8, such as the data management platform 10, via a bus or other communication network, such as the communication network 14. While not delineated in FIG. 16, the client device 12 includes at least one memory or memory device that can include a tangible and non-transitory computer-readable medium having stored therein computer programs, sets of instructions, code, or data to be executed by processor 130. FIG. 16 illustrates examples of modules and applications stored in memory on the client device 12 and operated by the processor 130. It can be appreciated that any of the modules and applications shown in FIG. 16 may also be hosted externally and be available to the client device 12, e.g., via the communications module 132.

In the example embodiment shown in FIG. 16, the client device 12 includes a display module 134 for rendering GUIs and other visual outputs on a display device such as a display screen, and an input module 136 for processing user or other inputs received at the client device 12, e.g., via a touchscreen, input button, transceiver, microphone, keyboard, etc. The client device 12 may also include a platform module 138, which may take the form of a customized app, plug-in, widget, or software component provided by the service provider platform 10 for use by the client device 12 to use in requesting a product or service and receiving a response that is determined at least in part using the decision engine 20. Similarly, the client device 12 may include an enterprise system application 142 provided by the enterprise system 16. The client device 12 in this example embodiment also includes a web browser application 140 for accessing Internet-based content, e.g., via a mobile or traditional website. The data store 144 may be used to store device data 146, such as, but not limited to, an IP address or a MAC address that uniquely identifies client device 12 within environment 8. The data store 144 may also be used to store application data 148, such as, but not limited to, login credentials, user preferences, cryptographic data (e.g., cryptographic keys), etc.

It will be appreciated that only certain modules, applications, tools and engines are shown in FIGS. 1 to 4 and 16 for ease of illustration and various other components would be provided and utilized by the service provider platform 10, client device 12, decision engine 20, and enterprise system 16 as is known in the art.

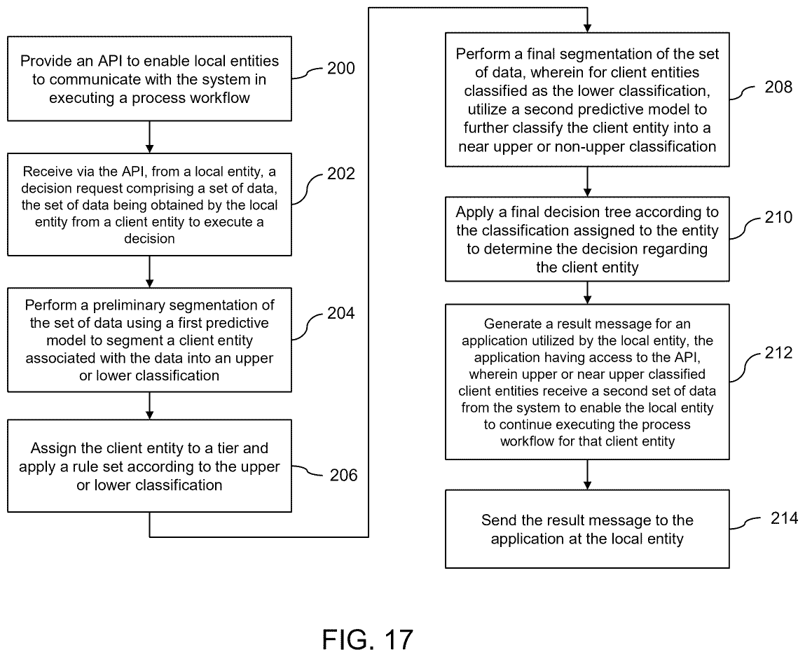

Referring now to FIG. 17, a flow chart illustrates operations that may be performed in executing decisions for a local entity by a remote system, e.g., for a service provider platform 10 by the decision engine 20. At block 200, the system provides an API 26, 28 to enable the local entities (e.g., service provider platforms 10) to communicate with the decision engine 20, e.g., via the enterprise system 16 or other system. This is done to enable access in executing a process workflow, such as that shown in FIG. 5.

At block 202, the decision engine 20 may receive, via the API 28, from a local entity (e.g., the application 24 at the service provider platform 10), a decision request 30 comprising a set of data, the set of data being obtained by the local entity from a client entity (e.g., the client device 12), to execute a decision. The decision may be associated with a response 32 to be provided to the request 30.

At block 204, the decision engine 20 may perform a preliminary segmentation of the set of data using a first predictive trained model 56 to segment a client entity associated with the data into an upper or lower classification (e.g., high and low priority). At block 206, the decision engine 20 may assign the client entity to a tier and apply a rule set according to the upper or lower classification. At block 208, the decision engine 20 may perform a final segmentation of the set of data. It can be appreciated that, for client entities classified as the lower classification, the decision engine 20 utilizes a second predictive trained model 56 to further classify the client entity into a near upper or non-upper classification (e.g., near prime versus non-prime).

At block 210, the decision engine 20 applies a final decision tree according to the classification assigned to the entity to determine the decision regarding the client entity. At block 212, the decision engine 20 may then generate a result message for an application 24 utilized by the local entity. Here, the application 24 has access to the API 26/28. Also, upper or near upper classified client entities receive a second set of data from the system to enable the local entity to continue executing the process workflow for that client entity. At block 214, the decision engine 20 generates a response 32 and thus is able to send the result message to the application 24 at the local entity.

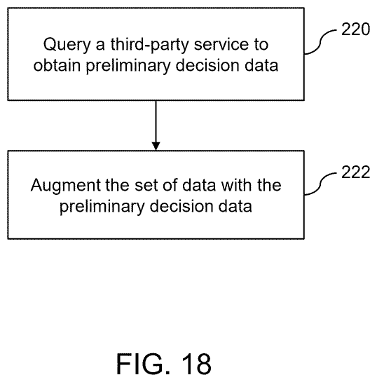

FIG. 18 is a flow chart illustrating example operations that may be performed in augmenting preliminary decision data with a set of data utilized in executing a decision. At block 220, the decision engine 20 may query a third-party service (e.g., the soft pull of credit bureau scores) to obtain preliminary decision data. At block 222, the decision engine 20 may augment the preliminary decision data with the set of data provided by the client entity. The operations shown in FIG. 18 may be performed in parallel or be integrated into the process shown in FIG. 17.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in the computing environment 8, or accessible or connectable thereto. Any application or module herein described may be implemented using computer readable/executable instructions that may be stored or otherwise held by such computer readable media.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A remote system for executing decisions for local entities, the remote system comprising:
a processor;
a communication module coupled to the processor; and
a memory coupled to the processor, the memory storing computer executable instructions that when executed by the processor cause the remote system to:
provide a connection to enable local entities to communicate with the remote system in executing a process workflow via a portal, the connection being available to a plurality of local entities to provide a centralized decision engine;
receive via the connection, from a local entity, a decision request comprising a set of data, the set of data being obtained by the local entity from an interaction with a client to execute a decision;
use access control permissions to access client data by the centralized decision engine;
execute a decision on behalf of the local entity using access to the client data and the received set of data by:
performing a preliminary segmentation of the set of data using a first predictive model to segment interaction into an upper or lower classification;
assigning the interaction to a tier and apply a rule set according to the upper or lower classification;
performing a final segmentation of the set of data, wherein for interactions classified as the lower classification, utilize a second predictive model to further classify the interaction into a near upper classification or the lower classification;
applying a final decision tree according to the classification assigned to the interaction to determine the decision regarding the interaction;
generating a result message for an application utilized by the local entity, the application having access to the connection, wherein upper or near upper classified client entities receive a second set of data from the remote system in the result message and cause the local entity to continue executing the process workflow for that interaction after receiving the result message; and
send the result message to the application at the local entity.

2. The remote system of claim 1, wherein the decision comprises an approval or denial of a service to the client entity.

3. The remote system of claim 1, further comprising instructions that when executed by the processor cause the system to:
query a third-party service to obtain preliminary decision data; and
augment the set of data with the preliminary decision data.

4. The remote system of claim 3, wherein the preliminary decision data comprises data indicative of qualification for receiving a service associated with the process workflow.

5. The remote system of claim 1, wherein the tier is associated with a risk.

6. The remote system of claim 5, wherein risk tiers are determined from associated look-up tables.

7. The remote system of claim 1, wherein the rule set comprises a segmented chart, the segmented chart comprising a plurality of rule categories.

8. The remote system of claim 1, wherein the preliminary segmentation comprises a feature selection process using a confusion matrix.

9. The remote system of claim 1, wherein the final segmentation comprises a feature selection process using a confusion matrix.

10. The remote system of claim 1, wherein the result message provides a prequalification decision that triggers a full qualification process.

11. The remote system of claim 10, wherein result messages comprising a negative decision inhibit the full qualification process from commencing.

12. A method for executing decisions for local entities, the method comprising:
providing a connection to enable local entities to communicate with a remote system in executing a process workflow via a portal, the connection being available to a plurality of local entities to provide a centralized decision engine;
receiving via the connection, from a local entity, a decision request comprising a set of data, the set of data being obtained by the local entity from an interaction with a client to execute a decision;
using access control permissions to access client data by the centralized decision engine;
executing a decision on behalf of the local entity using access to the client data and the received set of data by:
performing a preliminary segmentation of the set of data using a first predictive model to segment interaction into an upper or lower classification;
assigning the interaction to a tier and apply a rule set according to the upper or lower classification;
performing a final segmentation of the set of data, wherein for interactions classified as the lower classification, utilize a second predictive model to further classify the interaction into a near upper classification or the lower classification;
applying a final decision tree according to the classification assigned to the interaction to determine the decision regarding the interaction;
generating a result message for an application utilized by the local entity, the application having access to the connection, wherein upper or near upper classified client entities receive a second set of data from the remote system in the result message and cause the local entity to continue executing the process workflow for that interaction after receiving the result message; and
sending the result message to the application at the local entity.

13. The method of claim 12, wherein the decision comprises an approval or denial of a service to the client entity.

14. The method of claim 12, further comprising:
querying a third party service to obtain preliminary decision data; and
augmenting the set of data with the preliminary decision data.

15. The method of claim 14, wherein the preliminary decision data comprises data indicative of qualification for receiving a service associated with the process workflow.

16. The method of claim 12, wherein the rule set comprises a segmented chart, the segmented chart comprising a plurality of rule categories.

17. The method of claim 12, wherein the preliminary segmentation comprises a feature selection process using a confusion matrix.

18. The method of claim 12, wherein the final segmentation comprises a feature selection process using a confusion matrix.

19. The method of claim 12, wherein the result message provides a prequalification decision that triggers a full qualification process.

20. A non-transitory computer readable medium storing computer-executable instructions for executing decisions for local entities, comprising computer-executable instructions that, when executed by a remote computing system, cause the remote system to:
provide a connection to enable local entities to communicate with the remote system in executing a process workflow via a portal, the connection being available to a plurality of local entities to provide a centralized decision engine;
receive via the connection, from a local entity, a decision request comprising a set of data, the set of data being obtained by the local entity from an interaction with a client to execute a decision;
use access control permissions to access client data by the centralized decision engine;
execute a decision on behalf of the local entity using access to the client data and the received set of data by:
performing a preliminary segmentation of the set of data using a first predictive model to segment interaction into an upper or lower classification;
assigning the interaction to a tier and apply a rule set according to the upper or lower classification;
performing a final segmentation of the set of data, wherein for interactions classified as the lower classification, utilize a second predictive model to further classify the interaction into a near upper classification or the lower classification;
applying a final decision tree according to the classification assigned to the interaction to determine the decision regarding the interaction;
generating a result message for an application utilized by the local entity, the application having access to the connection, wherein upper or near upper classified client entities receive a second set of data from the remote system in the result message and cause the local entity to continue executing the process workflow for that interaction after receiving the result message; and
send the result message to the application at the local entity.
